(19) United States
(12) Patent Application Publication
(10) Pub. No.: US 2005/0086506 A1
(43) Pub. Date: Apr. 21, 2005

(54) Method for initialising an application terminals

(75) Inventor: Klaus U Klosa, Gruningen (CH)

Correspondence Address: RANKIN, HILL, PORTER & CLARK LLP, 4080 ERIE STREET, WILLOUGHBY, OH, 44094-7836, US

(73) Assignee: LEGIC IDENTSYSTEMS AG, Wetzikon (CH)

(21) Appl. No.: 10/498,646

(22) PCT Filed: Dec. 17, 2002
(86) PCT No.: PCT/CH02/00701

(30) Foreign Application Priority Data
Dec. 17, 2001 (CH) 2307/01

(51) Int. Cl. G06F 11/30; H04L 9/00

(52) U.S. Cl. 713/200; 380/270; 713/155

(57) ABSTRACT

The method for the initialisation or extension of an application for the transmission of information associated with an application to terminals of a system with mobile data carriers, terminals and with a hierarchical authorisation system utilises application information, which is loaded onto mobile data carriers from a selected, authorised terminal. Subsequently, during the presentation of the data carriers at further terminals, the application information is transmitted to the terminals associated with the application such that thereupon the application is capable of being executed for authorised data carriers at the terminals. The terminals are also capable of being transformed into further authorised terminals for the further controlled propagation or deletion of the application information (“virus” principle).

### BACKGROUND OF THE INVENTION

The invention is related to a method for the initialisation or extension of an application, i.e. for the transmission of information associated with an application to terminals, resp., read—and write stations of a system with mobile data carriers within the framework of a hierarchical authorisation system as well as a mobile data carrier. Systems with mobile data carriers (e.g., contact requiring and in preference contact-less identification media, chip cards or value cards, etc.) make it possible for the user to carry out corresponding applications at assigned read and write stations, such as the access to services (PC—access and goods), resp., the access to protected zones, buildings, events, etc.

An example for a system of this kind with contact-less identification media, resp., mobile data carriers and a hierarchical authorisation system is described in the WO 97/34265.

Above all in larger systems these applications time and again have to be extended, added to and modified at the various terminals, i.e., new or extended applications App have to be set-up in certain terminals. This renewal and adaptation of application programs up until now is only able to take place in two manners:
1. Terminals, which are connected with a central application computer, e.g., a host computer, from there may be provided with a new application, resp., with corresponding application programs and information. This, however, entails high costs for the making ready—and the operation of the online connections to the terminals. Decentralised terminals (in the meaning of stand-alone, offline) are not capable of being newly programmed or reprogrammed in this manner.
2. The terminals are individually reprogrammed by a service engineer by the exchanging of the program memory or by the loading of a new application program by means of a service device, which is connected through an interface. This entails high costs for this software changeover.

It now is the objective of the invention to find a new simple method for changing and setting-up applications in terminals and above all also in decentralised terminals. This objective is achieved in accordance with the invention by a method according to claim 1 and by a mobile data carrier according to claim 28.

### BRIEF SUMMARY OF THE INVENTION

In doing so, a new application App is loaded into a selected, authorised terminal WRZ of the system. The data carriers IM are presented at the authorised terminal, checked by it and if so required loaded with the new application information lex. If these loaded data carriers IMex are presented at further terminals WR of the system, then once again the data carrier is checked by the terminal and, if the new application App is associated with the terminal, then the application App, resp., the corresponding application information Iex is loaded into the terminal and in the following also executed by the terminal.

The dependent claims relate to advantageous further developments of the invention comprising particular advantages with respect to applications, security and adaptation to further conditions. In the following, the invention is further explained on the basis of Figures and examples.

### BRIEF DESCRIPTION OF THE SEVERAL VIEW OF THE DRAWINGS

FIG. 1a, b, c are schematic representations of the method in accordance with the invention with the transmission of a new application from an authorised terminal WRZ to a data carrier IMex, from the data carrier to another terminal WR and the execution of the application with further data carriers IM,

FIG. 2 is a schematic representation of an evolution of the method according to the invention with status feedback messages,

FIG. 3 is a schematic representation of an iterative evolution of the method in accordance with the invention by the transformation of a terminal WR into an authorised terminal WRZ,

FIG. 4a, b are schematic representations of the implementation of the method according to the invention the construction of an authorised terminal WRZ, of a data carrier IMex and of a terminal WR with the transmitted application information Iex,

FIG. 5a, b, c are schematic representations that illustrate the distribution of application information to the terminals WR and to the data carriers IMex as well as the execution of applications,

FIG. 6 is a schematic representation of a system with several authorised terminals WRZ, data carriers IMex and terminals WR, and

FIG. 7 is a schematic representation of an example of a system according to FIG. 6 with initialisations of several independent applications of independent users, with the information flow Iex and status feedback messages.

### DETAILED DESCRIPTION OF THE INVENTION

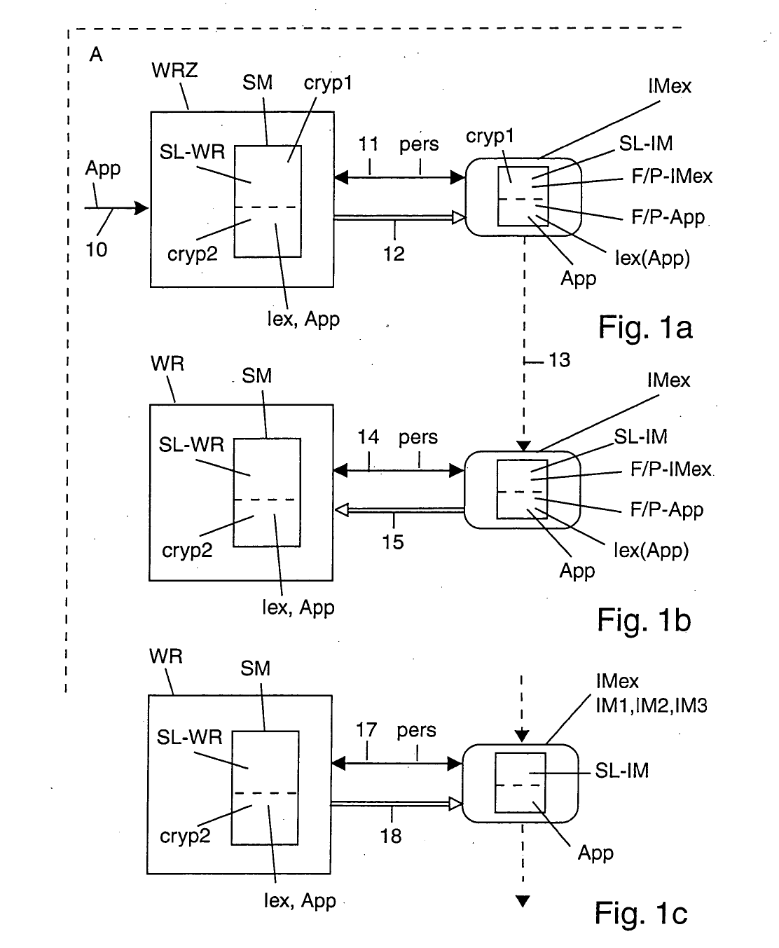

The FIGS. 1a, 1b, 1c, 2 and 3 illustrate the method according to the invention for the initialisation or extension of an application App, i.e., for the transmission of the application information Iex associated with an application App to terminals, resp., to read—and write stations WR of a system with mobile data carriers IM, terminals WR and a hierarchical authorisation system A. The application information Iex is loaded from a selected, authorised terminal WRZ onto mobile data carriers IMex and subsequently with the presenting of these data carriers IMex at further terminals WR the application information Iex is transmitted to these further terminals WR associated with the application, so that thereupon the application App is capable of being executed at these terminals WR for authorised data carriers IM and IMex.

A new or extended application App is loaded into a selected, authorised terminal WRZ (step 10 in FIG. 1a), e.g., into a security module SM with a security level SL-WR. As authorised terminals WRZ, in preference relatively central terminals are defined, which are frequented by many different data carriers IM, and from which the data carriers transmit the application information Iex onwards to the desired other terminals WR of the system. When presenting the data carrier IMex, the authorisation of the data carrier IMex for this application is verified by the authorised terminal WRZ (step 11) or vice-versa. In case of an authorisation being present, the application, resp., the application information Iex is written to the memory of the data carrier IMex (12) as is illustrated by FIG. 1a. Here in the data carrier IMex flag/pointers F/P are able to be set. When the data carrier subsequently is transmitted to further reading stations, resp., terminals WR of the system (13) and presented there, then between the terminal WR and the data carrier once again a verification takes place (14). In doing so, it is also possible to check the flag/pointers F/P of the data carrier IMex (15). By the data carrier or by the terminal WR it is verified, whether the new application is destined for this terminal WR and to what extent certain security requirements are fulfilled, e.g., whether the security level SL-WR of the terminals WR corresponds to the new application, resp., to the security level SL-IM of the data carrier. If this is the case, then the application information Iex is transmitted to the terminal WR (15), e.g., into a security module SM (FIG. 1b). Subsequently further data carriers IM1, IM2, IM3, etc., may be presented at and verified at this terminal WR (17), whereupon this new application App is also able to be transmitted to the further, authorised data carriers, e.g., IM1, IM3 by the terminal and if so required also executed on the transmitting data carrier IMex (18), (FIG. 1c), while on a non-authorised data carrier, e.g., IM2, the application is not able to be executed.

The execution of an application by a terminal WR immediately following the transmission of this application from the data carrier IMex to the terminal WR makes possible the implementation of applications with individual application profiles ind.

The data carrier IMex, however, is also capable of being utilised solely as a postman for the transmission of the application information Iex, without it being destined for the application App itself (without it being able to execute this application itself).

By means of flag/pointers F/P, it is possible to define or to verify, whether application information Iex is present on a data carrier IMex. In particular one has to differentiate between the following flag/pointers F/P:
Flag/pointer F/P-IMex of the data carrier IMex: A flag/pointer IMex is primarily associated with the data carrier IMex and is to make possible the management of application information Iex on the data carrier.
   A flag/pointer F/P-IMex in general refers to an application information Iex(App) or to an application App, which for its part contains application information Iex(App) and a flag/pointer F/P-App.
Flag/pointer F/P-App of an application App on a data carrier IMex: A flag/pointer F/P-App is primarily associated with the application App (e.g., as part of the application App) and is to make the management of application information lex of an application App more easy.

Within the framework of the transmission of application information Iex between the elements WR, WRZ and IMex one is able to differentiate whether these appear as active (i.e., making the application information Iex available as sender of their own accord) or passive (i.e., receiving the application information Iex as receiver).

The utilisation, i.e., the setting of flag/pointers F/P is a possibility for the implementation of active elements WR, WRZ, IMex. Thus during the step 15 (transmission of the application information Iex to the terminal WR), depending on requirements the terminal WR (active) is able to request from the data carrier, whether application information Iex is present (in that, e.g., the flag/pointer F/P-IMex is checked and if so required evaluated) or the data carrier IMex (active) is able to inform the terminal WR, that an application information Iex is present (in that, e.g., the flag/pointer F/P-IMex is transmitted to the terminal WR for a possibly required evaluation). This is also applicable in analogy for the sending back of status information Ist.

For the transmission of the application information Iex to the data carriers IMex and for the transmission from the data carriers IMex onto the terminals WR, an adequate authorisation is necessary. I.e., the transmission may only take place to, resp., by authorised data carriers IMex, resp., terminals WR, for which the application is destined and in such a manner, that the required security is assured. This authorisation is capable of being implemented in various ways and adapted, resp., selected according to the security requirements in correspondence with the type and the importance of the application, for example with the authorisation rules of the security level SL-IM corresponding to the system A, which are associated with the data carrier IMex, and security level SL-WR, which are associated with the terminals WR and which control the transmission of the new application information lex and its subsequent execution. In doing so, it is important, that the rules of the authorisation system A prevent, that it is possible for a security level SL-IM or SL-WR in a data carrier or in a terminal to be increased or changed. With this, the distribution of the applications App to the terminals WR and their utilisation is checked and restricted by means of the data carriers IM.

It is hereby possible to define the characteristics of the security level SL within the framework of the authorisation system A following or extending already present hierarchy levels, e.g., of organisation levels OL in accordance with WO 97/34265, or by new levels (with new principles) independent of existing levels.

There is, however, also the possibility, that the security levels SL are defined not within the framework of the authorisation system A, but rather within the framework of an additional, independent security authorisation system SA.

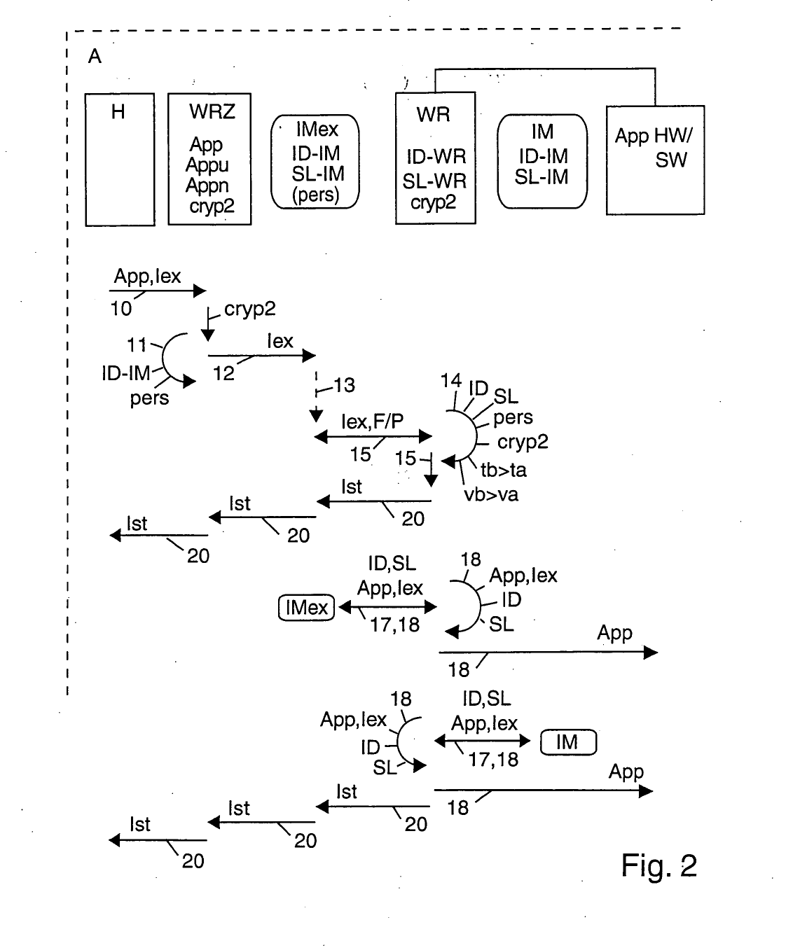

Further security—and controlling elements form identification data ID-IM und ID-WR or additional personal codes pers, as is further explained in FIG. 2. These may be linked with the security levels SL.

It is also possible to introduce a separate encryption cryp2 for the application. In doing so, the application information is encrypted with cryp2 in the authorised terminal WRZ, transmitted in encrypted form in the data carrier IMex and the transmitted application information Iex is only decoded again in the terminal WR with cryp2 (FIGS. 1a, 1b, 2). In this, the data carrier IMex in most cases must not to have at its disposal the code cryp2. This application information Iex must only be capable of being decoded in terminals WR or by data carriers IMex, to which a corresponding application is assigned.

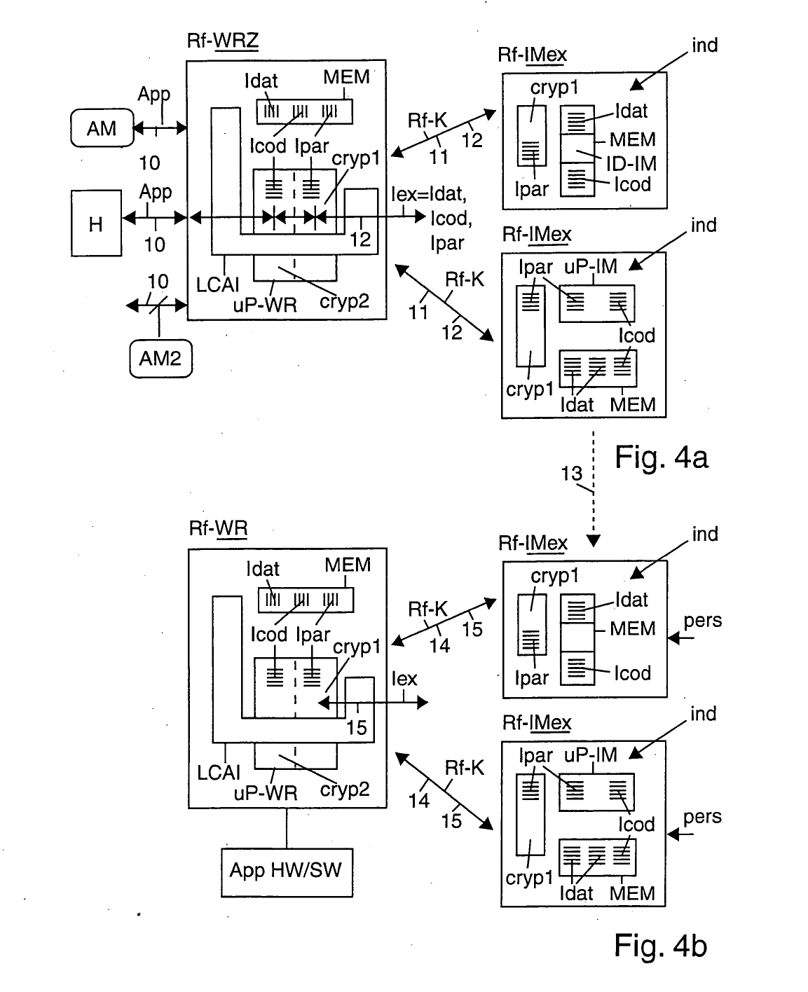

It is also possible, that for different independent applications App1, App2 of independent users and the assigned terminals WR also independent of one another encryptions cryp2 are selected. This encryption cryp2 of the application is independent of an encryption cryp1 of the contact-less communication Rf-K in contact-less systems, as is illustrated with the example of FIG. 4.

The new applications transmitted in accordance with the invention, resp., the corresponding application information Iex are to be understood as application extensions Appu (Update) of existing applications in the terminals WR or as new, not yet present applications Appn.

FIG. 2 illustrates the evolution of the method according to the invention as described in FIG. 1 with status feedback messages Ist. A new application App (Appn or Appu) is loaded into an authorised terminal WRZ from a host computer (a central station) H or from a transmission authorisation medium AM (step 10). There a data carrier IMex presented is controlled (step 11) and, if it is authorised and destined for it, application information Iex is written onto the data carrier (12), which subsequently is transmitted to further terminals WR of the system (13). Here it is checked, whether the terminal WR is associated with the new application (resp., whether the data carrier IMex is associated with the terminal WR) and whether all authorisations are present, e.g., by means of a verification of the mutual assignment of the security levels SL and of the reference-/serial numbers (step 14), whereupon the information Iex is written into, resp., transmitted to the terminal WR (15).

For the controlling of the authorisation and authentication at the authorized terminals WRZ or at the terminals WR associated with an application, the data carrier IMex may contain special identification data ID-IM. In this manner, the data carriers IMex are able to be defined for the transmission of selected application information Iex by means of identification data ID-IM.

And for the controlling of the authorisation and authentication at the terminal WR, special identification data ID-WR of the terminal are able to serve, with which the terminals WR are defined for the receiving of certain application information Iex.

During the transmission of the new application information Iex to the data carriers IMex and from the data carriers to the terminals WR, as an additional security requirement also a personal identification of the owner of the data carrier or of the owner of the terminal with a personal code pers (e.g., a PIN-Code or a biometric code) may be prescribed.

In order to prevent, that a newer application is inadvertently overwritten by an older application, it is possible to provide a control mechanism, e.g., with respect to time or by means of a version number. If an earlier application version App1a initialised by a data carrier IMex has been replaced by a later, new, modified version App1b, then it must be prevented, that this newly installed version subsequently once again is capable of being replaced by the old version App1a, e.g., if this old version is later presented at the terminal WR by another data carrier IMex, which still contains the old version. It is possible to achieve this by means of a time control, e.g., by dating the applications with respect to time and by means of the condition, that a younger application App1b with the point in time tb is not able to be replaced by an older version App1a with the point in time ta: Condition tb>ta. Another possibility consists in a controlling by means of a version number vn and the condition, that a younger application App1b with the version vb may not be deleted, resp., replaced by an older application App1 with the version va: Condition vb>va.

FIG. 2 also illustrates the sending back (step 20) of status information Ist concerning occurrences at the terminals WR with regard to the transmission of application information Iex, which are capable of being sent back to the authorised terminal WRZ by a data carrier IMex (the one, which has transmitted the application or by another one), e.g., concerning which application was correctly installed when in which terminal WR. Also status information Ist concerning the execution of the initialised application at the terminals WR are able to be sent back in this manner. Here the sending back may be initialised at different times, in preference by the terminal WR, e.g., immediately following the transmission of the application information Iex, at a predetermined later point in time or following a first time execution of the application with a data carrier IM. The sending back of status information is also capable of being employed for controlling the propagation of the application information Iex. In this manner, the complete transmission of the application information Iex from the data carrier IMex to the terminal WR is able to be made dependent on the fact, that the terminal WR transmits status information Ist to the data carrier IMex. This may take place by means of a shadow memory, which is described, e.g., in WO 97/34265.

FIGS. 2 and 4 in addition illustrate an application hardware/-software App HW/SW associated with a terminal WR for the physical execution of applications, resp., the physical configuration of a terminal (e.g., the controlling of a door access). This App HW/SW may contain active functional devices (such as motors, relays), input devices, display devices, biometric sensors, etc. FIG. 2 also depicts the execution of initialised applications at a terminal WR with the assigned active functional equipment App HW/SW (step 18) for a data carrier IMex or also for further data carriers IM presented in the following. With a newly initialised application, it is also possible for a terminal to carry out functions, for which the terminal originally was not conceived, this to such an extent as the App HW/SW necessary for this is present and to such an extent as it is capable of being configured by application information Iex in accordance with the requirements of the new application.

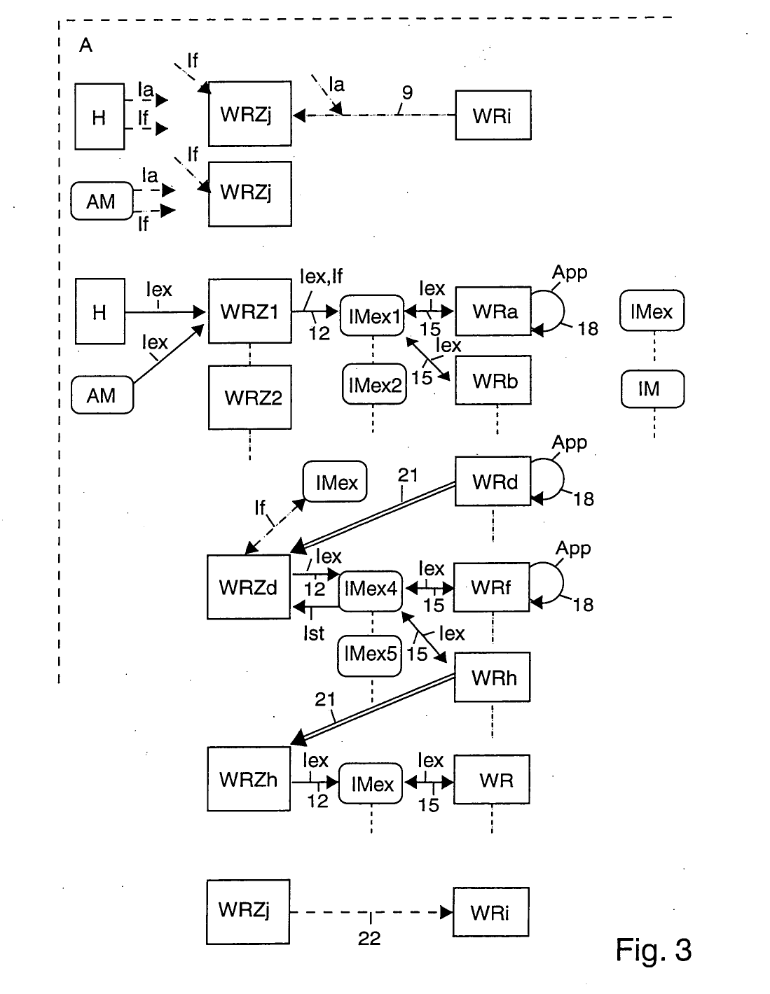

FIG. 3 illustrates the iterative evolution of the method according to the invention through the transformation of terminals WR into authorised terminals WRZ, this in the meaning of a controlled propagation, resp., deletion of new applications over several authorised terminals WRZ (virus principle). In doing so, first authorised terminals WRZJ are selected, in general within the framework of the authorisation system A, possibly also by the transformation of terminals WRi into authorised terminals WRZj (step 9). Through these authorised terminals WRZJ subsequently the transmission of application information Iex onto data carriers IMex and by the data carriers IMex to further terminals WR is carried out. One or several of these terminals WR as a result of the transmission of application information Iex may be transformed into authorised terminals WRZ. Subsequently the application information from these further authorised terminals WRZ is loaded into further data carriers IMex, through which the application information Iex once again is transmitted to further normal terminals WR. Terminals transformed from a terminal WRi into an authorised terminal WRZj at any time (in preference after the application information has been transmitted to all terminals WR of a system) are capable of being transformed back into terminals WRi again (step 22). FIG. 3 depicts a controlled, iterative propagation of the application information Iex of this kind. At the beginning of the method there is the selection of an authorised terminal WRZ. This may be an authorised terminal WRZj, which within the framework of the system was selected right from the beginning as authorised. It is also possible, however, to transform a terminal WRi into an authorised terminal WRZj (step 9). The transformation into an authorised terminal WRZj may be dependent on an authorisation by means of authorisation information 1a, which is carried out through a host computer H or an authorisation medium (a data carrier) AM. If not an enabling of the functionality as an authorised terminal WRZ by means of release information If is to take place beforehand (as additional, optional security measure), then an authorised terminal WRZ subsequently is ready for the acceptance of application information Iex. In the latter case, the transmission of application information Iex counts as an implicit enabling. In the first case, the enabling takes place by means of release information If, in preference once again through a host computer H or an authorisation medium AM. Departing from one or from several central terminals WRZ1, WRZ2, the application information Iex thereupon through the data carriers IM1ex, IM2ex is transmitted to several terminals WRa, WRb, . . . , WRd, at which subsequently the new application App is capable of being executed (step 18). Selected from these are certain terminals, e.g., WRd, which for their part are transformed into the status of an authorised terminal WRZd (step 21). Also through these new authorised terminals WRZd it is possible to transmit the application information Iex to further terminals WRf, . . . , WRh by means of data carriers IMex4, IMex5 in a controlled manner, possibly following the enabling by means of release information If. For this new authorised terminal WRZd the transmission of the release information If in preference is carried out through IMex. As is evident, for the transmission of application information Iex to the data carriers IMex4 and IMex5, no direct contact with an authorised terminal linked to a host computer H, e.g., WRZ1, is necessary. This iterative principle may be repeated as frequently as required, e.g., the terminal WRh is capable of being transformed into the authorised terminal WRZh. This makes possible the controlled transmission of the application information Iex within a system with various authorised terminals WRZ, various terminals WR and data carriers IM, resp., IMex and with this a more rapid and specific propagation of a new application within a system.

An important aspect for the controlled propagation is the possibility of transforming a terminal WRd, WRh into an authorised terminal WRZd, WRZh, without the terminal having to be connected with a host computer H and without the application information Iex having to be transmitted into the terminal by means of an additional, special transmission authorisation medium AM. This leads to further cost reductions during the introduction, resp., initialisation of new applications, because it is possible to make do without the linking of the individual terminals WR to the host computer H or without the transmission on site into every individual terminal WR by means of a transmission authorisation medium AM. The users of a system, i.e., the holders of the identification media (data carriers) IMex, propagate a new application in the system in the simplest possible manner: by the utilisation of the system.

In analogy to this controlled propagation in accordance with the virus principle, it is also possible to carry out a controlled deletion of an application App, independent of how and from where this application has been loaded into, resp., transmitted to a terminal WR.

In this, it is also possible for a terminal WR to be transformed into an authorised terminal WRZ only temporarily. Thus it is possible for a transformed authorised terminal WRZ (e.g., WRZd) after a certain time period or on the basis of certain criteria to be transformed back into a normal terminal WRd again, e.g., after the application information Iex has been transmitted to a predefined number of data carriers IMex or in dependence of certain status information Ist.

Also here it is applicable, that an authorised terminal, e.g., WRZd, does not have to transmit application information Iex to all IMex, but solely if it is meant for this.

It is also possible, that a terminal WR is transformed into an authorised terminal WRZ solely for the transmission of status information.

The FIGS. 4a, 4b illustrate a structure of the components WRZ, IM and WR as well as the communication and the information flow in the method according to the invention. This example shows a contact-less system Rf with contact-less communication Rf-K between the elements Rf-WRZ, Rf-IMex, Rf-WR. In comparison with contact systems, contact-less systems provide further particular advantages and expanded application possibilities. In this, the contact-less communication Rf-K is encrypted, e.g., by means of an encryption cryp1 by means of a unit for the logical processing of information, e.g., a processor for the communication logic both in the data carriers IM as well as in the terminals WR.

The authorised terminal Rf-WRZ contains a data memory MEM as well as a microprocessor uP-WR for the storage, resp., processing of the application information Iex as well as for the communication and for further security—and control functions. In this, the application information Iex=Idat, Ipar, Icod may contain:
Idat Application data, e.g., identification numbers, keys, codes for encryption (cryp)
Ipar Parameters, e.g., adjustable parameters for the configuration, resp., selection of the communication, type, performance, encryption of the communication, communication protocols, interfaces to the App HW/SW, etc.
Icod Program data, resp., program code.

This FIG. 4 illustrates two types of possible data carriers Rf-IMex:

One data carrier without application microprocessor uP-IM, with a memory MEM for the application information Iex and one data carrier, which in addition comprises an application microprocessor uP-IM. This makes it possible, that the data carrier IMex itself is capable of executing an application or a part of an application. In doing so, the corresponding program code Icod is not transmitted to the terminal WR, but remains in the data carrier IMex and is executed, resp., controlled by the application processor uP-IM of the data carrier, which with this forms an extension of the application processor uP-WR, possibly also of the App HW/SW. The compliance with the rules of the authorisation system A, however, also in the case of an extension of this kind is carried out through the terminal WR, i.e., the application data Idat necessary for this (in general that processed by the application Icod) has to be made available to the terminal WR by the data carrier IMex prior to the execution of an application.

FIG. 4a depicts the transmission of the application information Iex=Idat, Ipar, Icod by the authorised terminal Rf-WRZ onto the data carrier Rf-IMex and FIG. 4b illustrates the transmission from the data carrier RF-IMex to the terminals Rf-WR.

Die Terminals WR may contain a logical communication—and application interface LCAI (Logical Communication and Application Interface), through which application information Iex is loaded into the terminals and is capable of being read out.

The terminals WR in this example contain a logical communication—and application interface LCAI, which ensures, that the microprocessor of the terminal WR understands the application information Iex, e.g., the language of the program code Icod and is capable of processing it in compliance with the rules of the authorisation system A. The logical communication—and application interface LCAI comprises in essence three tasks:
In the first instance it acts as an interpreter or virtual machine, in particular for the processing of program data Icod and parameters Ipar,
secondly as an application programming interface API, in particular for the processing of application data Idat and also for the processing of program data Icod and parameters Ipar, in particular of data, which is directly associated with the application, resp., which is only understood by the application
and thirdly it ensures the compliance with the rules of the authorisation system A.

The API represents a software interface for the standardised access to functions of a program, so that the logical rules for the execution of the application are complied with.

Correspondingly the writing (12) of application information Iex onto a data carrier IMex has to be carried out through the logical communication—and application interface LCAI. In analogy, also the transmission (15) of application information Iex from the data carrier IMex to a terminal WR has to be carried out through the logical communication—and application interface LCAI, where in addition also the controlling of the security level SL may take place.

FIG. 4a further illustrates two possibilities of transmitting the application information Iex in a controlled, authorised manner in compliance with the rules of the authorisation system A to an authorised terminal WRZ for the first time. The transmission may be carried out by a transmission authorisation medium AM (which contains the application information Iex and simultaneously serves for the authorisation according to the authorisation system A) or by a host computer H. In case of a transmission through the host computer H, the rules of the authorisation system A have to be complied with in a different manner, e.g., in that the communication between the host computer H and the authorised terminal WRZ is explicitly enabled by an authorisation medium AM2, in preference through a contact-less communication Rf-K with the WRZ. Here already the transmission (10) of the application information Iex into the authorised terminal WRZ is able to take place through the logical communication—and application interface LCAI of the terminal, this as an additional security measure.

The logical communication—and application interface LCAI is an important element for the compliance with the rules of the authorisation system A over all levels and for all terminals WR, WRZ and data carriers IM of the system.

It is also possible, that terminals are provided, which do not yet contain any application, so-called generic terminals g-WR with an application microprocessor uP-WR, into which an application Iex is temporarily loaded and also executed by a data carrier IMex. Subsequently this application information Iex may be deleted again. Thus in principle any data carrier IM is capable of bringing along its application itself, e.g., for a one-time access or for the implementation of applications with individual application profiles ind.

A further advantage of generic terminals g-WR consists in the fact, that they have to have a relatively flexible application processor uP-WR. This may be made available to a data carrier IM, IMex, which itself does not have an application processor uP-IM, i.e., the uP-WR is capable of being utilised for the simulation of a not present uP-IM. This makes possible the simultaneous utilisation of data carriers IM, IMex with and without application processor uP-IM within the same system.

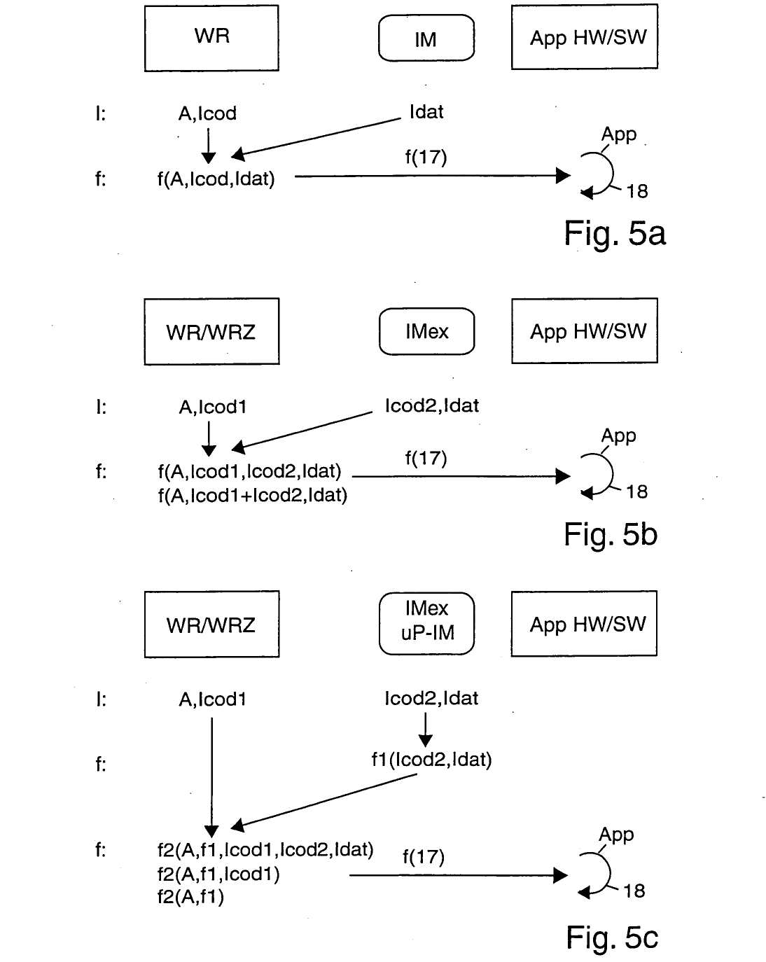

The FIGS. 5a, b, c illustrate the propagation of application information lex, i.e., of application data Idat and program codes Icod to the terminals WR, WRZ and to the data carriers IM, IMex as well as the execution (18) of applications App at the assigned functional equipment App HW/SW under compliance with the rules of the authorisation system A. The application data Idat and the program codes Icod are processed in the terminal WR and the compliance with the authorisation rules A is controlled by the formation of a function f(A, Icod, Idat). Following the successful controlling (17) of this function, the application is executed in the assigned functional equipment App HW/SW (18).

FIG. 5a describes the prior art for contact-less systems. Here a strict separation between the program code Icod in the terminal WR and the application data Idat in the data carrier IM takes place. The compliance with the authorisation rules A is carried out in the terminal WR by means of the determination of a function f(A, Icod, Idat) by the application processor uP-WR of the terminal.

FIG. 5b describes a new possibility in accordance with the method according to the invention. The up until now strict separation between the program code Icod1 in the terminal WR or WRZ and the application data Idat in the data carrier IMex is eliminated. Parts of the program code Icod2 (or also the complete program code) here are contained in the data carrier IMex. The program code Icod2 like the application data Idat is transmitted to the terminal WR, WRZ. The compliance with the rules is carried out in the terminal WR through the determination of a function f(A, Icod1, Icod2, Idat) with separate processing of Icod1, Icod2, or a function f(A, Icod1+Icod2, Idat) with combined processing of Icod1 and Icod2, by the application processor uP-WR of the terminal.

FIG. 5c describes a further new possibility, if the data carrier IMex also has an application processor uP-IM at its disposal. In this case, in the data carrier IMex a function f1(Icod2, Idat) is able to be determined by the uP-IM, which may be utilised for the determination of the function f2 in the terminal. This function f2 may be: f2(A, f1, Icod1, Icod2, Idat) or f2(A, f1, Icod1) or in the simplest form f2(A, f1). In the simplest form, in the terminal WR, WRZ only the compliance with the rules of the authorisation system A is carried out and there is no processing of Idat, Icod1 and Icod2 in the terminal, but only in the data carrier IMex.

The FIGS. 5b and 5c make clear also the concept of the generic terminal g-WR, which is characterised by the fact, that in the terminal WR no program code Icod1 associated with an application is present, but only a program code Icod2 in the data carrier. The FIGS. 5b and 5c also illustrate the basis for the implementation of applications with individual application profiles ind, inasmuch as at the authorised terminal WRZ both the program code Icod necessary for the individualisation as well as the necessary application data Idat are loaded into the data carrier IMex.

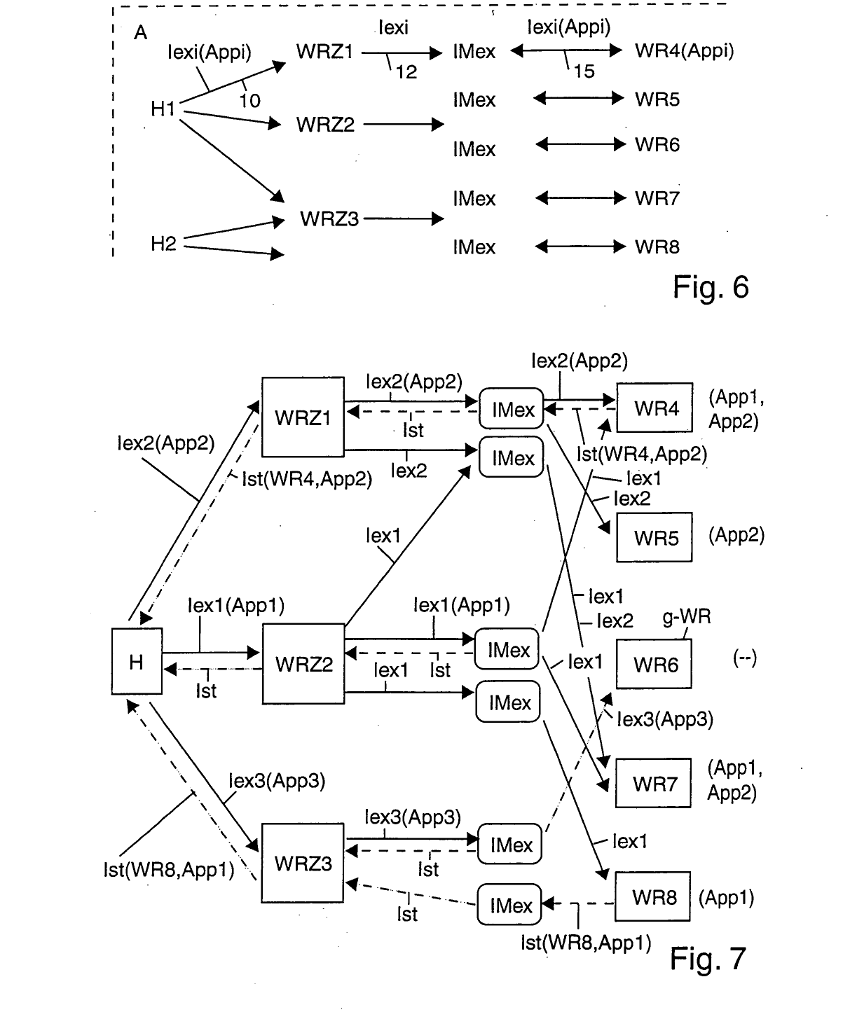

FIG. 6 schematically illustrates a system according to the invention for the initialisation of applications App by means of application information Iex, which is transported from authorised terminals WRZ through data carriers IMex to terminals WR associated with the applications App, written into these and also executed there. The example shows several central host computers H1, H2, several authorised terminals WRZ1, WRZ2, WRZ3 and several terminals WR4-WR8. Within the framework of the authorisation system A, in principle any types of different and independent applications are capable of being initialised through the authorised terminals WRZ and the data carriers IMex in the various assigned terminals WR in any combination required, this to such an extent as the memory capacities are sufficient for this (FIG. 7).

FIG. 7 illustrates an example of an embodiment of a system according to FIG. 6 with three different independent applications App1, App2, App3 of independent users, which are transmitted to the mobile data carriers IMex from the authorised terminals WRZ1, WRZ2, WRZ3 and from these are transmitted to assigned terminals WR4-WR8, e.g., from the WRZ1 the application App2 into the terminals WR4, 5, 7, from the WRZ2 the application App1 into the terminals WR4, 7, 8 and from the WRZ3 the application App3 temporarily into the terminal WR6 (as g-WR).

After the applications have been installed in the terminals WR, corresponding sending back of status information Ist by the data carriers IMex to the authorised terminals WRZ takes place and from these to the central host computer H, e.g.: the application App1 is installed in the terminal WR8, is sent back to WRZ3 and H.

In practice, in most instances several data carriers IMex will present the same application Iex to a selected terminal WR, where of course this application only has to be transmitted to this terminal once. Equally the same status information Ist with respect to the writing of a certain application into a selected terminal WR may be sent back by several data carriers IMex to the authorised terminals WRZ (and to the host computer H). After all required applications have been installed in all required terminals WR, this application in principle is able to be deleted on the data carriers IMex and in the authorised terminal WRZ, resp., further transmissions to the IMex may be stopped. And after all necessary status information messages Ist have been sent back, it is also possible to stop the sending back of further status information.

The sending back of status information with respect to the execution of applications at the terminals WR is also capable of being continued if so required, this to such an extent and for how long such messages are required.

Depending on the requirements, it is also possible, that the application information Iex is only temporarily present on the data carriers IMex, in the terminals WR and/or in the authorised terminals WRZ and and that it is subsequently deleted. In this, the application information Iex may be temporarily present during a predefinable time period or for a certain number or types of processes or until a certain condition has been fulfilled.

Examples for the initialisation of applications in terminals according to the invention: These may concern new applications Appn or an update of existing applications, which are replaced, resp., completed by a modified, extended application Appu.

One example for an update application Appu: The access to a room shall take place by the checking of the reference number of a data carrier IM1 and by the entering of a PIN-Code by the owner of this data carrier IM1. This existing application is to be extended, so that the access is only possible, if within a short time period (e.g., 30 seconds) a second authorised data carrier IM2 is presented and the PIN-Code of this second person is entered at the terminal. This extended application Appu is adapted in such a manner, that the checking process is respectively run through twice. The functional equipment App HW/SW for the physical execution of this application has to already be present at the terminal WR.

As a further example of an application extension Appu, an existing 4-digit PIN-Code as access condition could be replaced by a 6-digit PIN-Code with the Appu.

Example of a new application Appn: The access up until now was implemented by checking the reference number of a data carrier IM. Now, additionally also the entering and verifying the PIN-Code of the owner of the data carrier IM shall take place. For this purpose, through a data carrier IMex a new application Appn is installed in the terminal WR, wherein the necessary functional equipment App HW/SW is already present at the terminal or is capable of being simulated, e.g., with a PSOC (Programmable System on Chip), a module comprising a microprocessor and an analogue part, wherein the functionality of the analogue part is capable of being defined and changed by the microprocessor within certain limits (i.e., in the broadest sense, by means of software the hardware of the module is simulated). With new applications Appn therefore also a new and extended exploitation of existing equipment, resp., functional equipment is capable of being set-up at the terminals WR.

The adaptation of a characteristic value of a functional device is illustrated as an example of an application by an update of an application Appu in combination with a re-configuration of the App HW/SW. The application shall consist of the automatic opening of a door, in that, e.g., a relay clears a contact, a locking pin is mechanically moved and a motor opens the door. For the compensation of the aging and wear of these components, the terminal WR is capable of being re-configured through application information Iex. For this purpose, an update of the application parameters Ipar of the functional devices (relay, motor) belonging to the App HW/SW is transmitted to the terminal WR, as a result of which the relay and the motor are operated with new reference values (e.g., with an increased current), this in order to prevent, that in case of an operation with the old reference values the relay does not clear the locking pin, resp., the door jams.

The data carriers IMex may also comprise application information Iex with individual application profiles ind.

For example, it is possible that individual access times for every person are only stored on their own data carrier IM, while only the general access condition is written into the terminals WR as an application. Or it is also possible to initialise applications Iex with an individual profile ind, which depending on the owner of the data carrier IMex are different. For example, the access to a room is to be differently controlled in the terminal WR. For a certain circle of closer employees only the checking of the reference number of their data carriers is necessary, while for other persons also a checking of their PIN-Code in addition to the reference numbers is required.

Temporary access card for selective access: For an access system to production facilities of a daughter company in country b new access cards are to be established, with which persons responsible from the central office in country a are able to carry out unannounced control visits in country b. For this purpose, in the central office data carriers IMex are capable of being loaded with the corresponding application information Iex at an authorised terminal WRZ. In country b, the data carriers IMex are presented at the terminals there, the application is temporarily initialised and also executed, i.e., the access is permitted for the duration of the planned control visit.

A further example: An application is to consist of the access clearance for an EDP centre, wherein the data carrier of the card owner is checked. This access clearance is now to be tightened by a new, extended application App, with which the access control additionally requires a personal code pers (PIN-Code or biometric code) of the owner of the data carrier. Furthermore, certain data or information is to be issued or displayed. If the terminal does not have a display, then there is the possibility of attaching a display unit next to the terminal, which, e.g., like the data carrier is to communicate with the terminal in a contact-less manner. This makes it possible to make do without a cabling of the display unit (with the terminal WR or with a host computer H). In case of an extension of this kind, the terminal has to be brought into a position to address the display unit, i.e., the terminal, resp., its corresponding parameters Ipar have to be reconfigured in such a manner, that the communication is possible both with a data carrier IMex as well as with the display unit. The application information Iex required for this purpose is transmitted into the terminal WR through a data carrier IMex. In the case of an application with an individual application profile ind furthermore, e.g., on the basis of the application information Iex on the data carrier IMex it is decided, whether the display unit is a component part of the application App and how it is to be addressed by the terminal WR.

A further enhancement of the access security is capable of being initialised, e.g., with an additional tightening by a further application App2, with which the access is only permitted in twos, i.e, in the extended application App2 the terminal checks the data carrier of a first person and this person's personal code and subsequently the data carrier of a second person and that person's personal code, whereupon solely in case of a matching of all data the access to the EDP centre is enabled.

Within the framework of this description, the following terms are utilised:

| H | Host computer, central station |
|---|---|
| A | Authorisation system |
| AM | Authorisation means, transmission - authorisation |
| | medium |
| IM | Mobile data carrier, identification medium |
| IMex | IM for the transmission of application information lex |
| Rf | Contact-less |
| Rf-K | Contact-less communication |
| WR | Terminal, read - and write station |
| WRZ | Authorised terminal, selected central terminal |
| g-WR | Generic WR |
| App | Application |
| Appn | New application |
| Appu | Application extension, update |
| App1, App2 | Independent applications |
| ind | Individual application profiles |
| App HW/SW | Application - hardware/ - software for WR, |
| | functional equipment |
| lex | Application information |
| Idat | Data of an application |
| Ipar | Parameters |
| Icod | Program data, program code |
| lex = | Idat, Ipar, Icod |
| Ist | Status information |
| f | Function with control data |
| SL | Security level |
| SL-IM, SL-WR | SL of IM, resp., of WR, WRZ |
| ID | Identification data |
| ID-IM, ID-WR | ID of IM, resp., ID of WR, WRZ |
| SM | Security module |
| MEM | Memory, data memory |
| API | Application programming interface |
| cryp1 | Encryption of the communication |
| cryp2 | Encryption of the application |
| pers | Personal data or code (PIN, biometric code) |
| uP-WR | Microprocessor in WR for App |
| uP-IM | Microprocessor in IM for App |
| ta, tb | Points in time |
| va, vb | Version numbers |
| Ia | Authorisation information |
| F/P | Flag/Pointer |
| F/P-IMex | F/P of IMex |
| F/P-App | F/P of an application with Iex(App) |
| If | Release information |
| 9 | Transformation/conversion of WR to WRZ, |
| | selection, authorisation |
| 10 | Loading new application into WRZ |
| 11 | Controlling of IMex |
| 12 | Writing of lex, setting of F/P |
| 13 | Transfer of the IMex |
| 14 | Controlling of WR, IMex |
| 15 | Transmission to WR |
| 17 | Controlling of IM |
| 18 | Execution of App |
| 20 | Sending back of status information |
| 21 | Transformation/conversion of WR into WRZ |
| 22 | Retransformation of WRZ into WR |

1. A method for initialisation or extension of an application (App), for transmitting application information (Iex) associated with one application (App) to terminals, said terminals being read—and write stations (WR) of a system with mobile data carriers (IM), terminals (WR) and a hierarchical authorisation system (A), comprising the steps of:
selecting and authorizing certain terminals (WRZ),
loading the application information (Iex) into mobile data carriers (IMex) by an authorised terminal WRZ
and, subsequently during presentation of said data carriers (IMex) to other terminals (WR), transmitting the application information (Iex) to these other terminals (WR) associated with the application,
so that thereafter the application (App) for authorised data carriers (IM) and (IMex) is capable of being executed at these other terminals (WR).

2. The method according to claim 1, comprising the further step of transforming a terminal (WR) into an authorised terminal (WRZ) by means of authorisation information (Ia).

3. The method according to claim 1, wherein loading of application information (Iex) from an authorised terminal (WRZ) onto a data carrier (IMex) takes place following the enabling of the authorised terminal (WRZ) by means of release information (If).

4. The method according to claim 1, wherein the system comprises a contact-less communication (Rf-K) between the terminals (WR, WRZ) and the data carriers (IM, IMex).

5. The method according to claim 1, wherein the application information (Iex) is capable of containing application data (Idat), application parameters (Ipar) and program data (Icod).

6. The method according to claim 1, wherein, from the mobile data carriers (IMex) status information (Ist) concerning occurrences at the terminals (WR) relating to the transmission of the application information (Iex) and to the execution of the corresponding applications is sent back to the authorised terminals (WRZ).

7. The method according to claim 1, wherein a terminal (WR) by means of the transmission of application information (Iex) through a data carrier (IMex) is transformed into a further authorised terminal (WRZ) and that subsequently the application information (Iex) from this further authorised terminal (WRZ) is loaded onto further data carriers (IMex), through which the application information (Iex) once again is transmitted to further terminals (WR).

8. The method according to claim 7, wherein a terminal (WR) is transformed into an authorised terminal (WRZ) only temporarily.

9. The method according to claim 7, wherein a terminal (WR) is transformed into an authorised terminal (WRZ) only for transmission of status information.

10. The method according to claim 1, wherein the application information (Iex) is only temporarily present on the data carriers (IMex), the terminals (WR) and/or the authorised terminals (WRZ) and subsequently deleted therefrom.

11. The method according to claim 10, wherein the application information (Iex) is temporarily present for one of a predetermined time period, for a certain number of processes, and for a certain type of processes.

12. The method according to claim 1, wherein a control mechanism is provided, which ensures, that a newer application (Appb) in a terminal (WR) is not able to be overwritten by an older application (Appa), which is presented at a later point in time by another data carrier (IMex).

13. The method according to claim 12, wherein the control mechanism comprises one of a time control (tb>ta) and a version control (vb>va).

14. The method according to claim 1, wherein the data carriers (IM) contain a security level SL-IM and the terminals (WR) contain a security level (SL-WR), which control the transmission of the new application (App) onto the data carriers (IMex) and into the terminals (WR) for their subsequent execution.

15. The method according to claim 14, wherein the security levels (SL) are a functional component part of the authorisation system (A) and that the rules of the authorisation system (A) prevent, a security level (SL-IM; SL-WR) in a data carrier (IM) or in a terminal (WR) from being increased.

16. The method according to claim 1, wherein the application information (Iex) for the transmission from the authorised terminal (WRZ) to the terminals (WR) is encrypted with a separate encryption (cryp2) and is solely capable of being decoded in terminals (WR) or by data carriers (IMex), which are associated with an application corresponding to the application information (Iex).

17. The method according to claim 1, wherein the data carriers (IMex) for the transmission of selected application information (Iex) are defined by identification data (ID-IM).

18. The method according to claim 1, wherein the terminals (WR) are defined by identification data (ID-WR) for the reception of selected application information (Iex).

19. The method according to claim 1, wherein, for the transmission of the new application (App) onto the data carriers (IMex) or from the data carriers into the terminals (WR), as an additional security requirement a personal identification (pers) of the card owner or of the owner of the terminal is required.

20. The method according to claim 1, wherein, for the transmission of the application information (Iex) or of status information (Ist) the data carriers (IMex) and/or the terminals (WR) are capable of operating actively so as to make available information (Iex, Ist) on their own).

21. The method according to claim 1, wherein, in the data carriers (IMex) with the transmission of application information (Iex) flag/pointers (F/P) are also set.

22. The method according to claim 1, wherein the data carriers (IMex) comprise an applications microprocessor (uP-IM), which in collaboration with the applications microprocessor of the terminal (uP-WR) is capable of processing application information (Iex).

23. The method according to claim 1, wherein the data carriers (IMex) comprise application information (Iex) with individual application profiles (ind).

24. The method according to claim 1, wherein generic terminals (g-WR) with an applications microprocessor (uP-WR) are provided, in which a selected application is not contained and into which this application is temporarily loaded by a data carrier (IMex).

25. The met hod according to claim 1, wherein the terminals (WR) contain a logical communication—and application interface (LCAI), through which application information (Iex) is capable of being loaded into the terminals and read out.

26. The method according to claim 25, wherein an application (App) is only capable of being executed following the loading and reading out through the logical communication—and application interface (LCAI).

27. The method according to claim 25, wherein the logical communication—and application interface (LCAI) ensures the compliance with rules of the authorisation system (A).

28. The method according to claim 25, wherein controlling of the security level (SL) is carried out in the logical communication—and application interface (LCAI).

29. The method according to claim 25, wherein the logical communication—and application interface (LCAI) comprises an interpreter or an application programming interface (API).

30. The method according to claim 1, wherein several independent applications (App1, App2), each respectively of independent users for assigned terminals (WR1, WR2), each respectively at assigned authorised terminals (WRZ1, WRZ2) are loaded onto the mobile data carriers (IMex) and each respectively transmitted to corresponding assigned terminals (WR1, WR2).

31. A mobile data carrier in a system with data carriers (IM), assigned terminals BR and a hierarchical authorisation system (A), wherein the data carrier (IMex) in a data memory contains a new or extended application (App) with application information (Iex) loaded from a selected, authorised terminal (WRZ), which when the data carrier is presented at further terminals WR (WR) associated with the application is written in and in the following is also capable of being executed by the terminals.

32. The mobile data carrier according to claim 31, wherein the data carrier (IMex) contains application information (Iex1, Iex2) of different independent applications (App1, App2), which are capable of being transmitted to different assigned terminals (WR1, WR2).

33. A system mobile data carriers (IM), terminals (WR) and a hierarchical authorisation system (A), comprising at least one selected, authorised terminal (WRZ), at which new or extended applications (App) with application information (Iex) are loaded onto the data carrier (IMex), which information (Iex) at further terminals (WR) associated with the application (App) is written into these and is also executed by the terminals.
